(19) United States
(12) Patent Application Publication
(10) Pub. No.: US 2007/0155558 A1
(43) Pub. Date: Jul. 5, 2007

(54) Continuously variable transmission

(76) Inventors: Robert W. Horst, San Jose, CA (US); Richard R. Marcus, Mountain View, CA (US)

Correspondence Address: PERKINS COIE LLP, P.O. BOX 2168, MENLO PARK, CA, 94026, US

(21) Appl. No.: 11/649,496

(22) Filed: Jan. 3, 2007

Related U.S. Application Data
(60) Provisional application No. 60/755,466, filed on Dec. 30, 2005.

(51) Int. Cl. F16H 7/12; F16H 7/14

(52) U.S. Cl. 474/133; 474/134; 474/114; 474/117

(57) ABSTRACT

A technique for providing a variable-ratio coupling between output shaft and input motor involves driving an output shaft with drivers that are out of phase with each other. Advantageously, the technique provides a gear reduction via a simple, high-efficiency mechanism; continuous output torque is provided by alternating the load between two belts deflected by, by way of example but not limitation, cam devices. The technique provides high torque and allows the torque to be traded for speed at a given power level, and provides continuous output torque when operated as a motor or continuous braking forces when operated as a generator. A system according to the technique can be used as a transmission to couple rotary or oscillating forces from an input drive shaft to a continuous, variable-ratio output shaft.

### CROSS REFERENCE TO RELATED APPLICATIONS

This Application claims the benefit of U.S. Provisional Application No. 60/755,466 filed Dec. 30, 2005, the disclosure of which is incorporated herein by reference.

### BACKGROUND

Motors and actuators are used in a wide variety of applications. This may call for a variable ratio transmission (VRT) between the primary driver input and the output of an actuator. VRTs may be used in vehicles, industrial machinery, or other devices.

In the past, several different techniques have been used to construct a VRT. Some examples of implementations of VRTs include Continuously Variable Transmissions (CVTs) and Infinitely Variable Transmissions (IVTs). The underlying principle of most previous CVTs is to change the ratio of one or more gears by changing the diameter of the gear, changing the place where a belt rides on a conical pulley, or by coupling forces between rotating disks with the radius of the intersection point varying based on the desired ratio. Prior art CVTs have drawbacks in efficiency, complexity, maximum torque, and range of possible ratios.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for providing a variable-ratio coupling between output shaft and input motor involves driving an output shaft with drivers that are out of phase with each other. Advantageously, the technique provides a gear reduction via a simple, high-efficiency mechanism; continuous output torque is provided by alternating the load between two belts deflected by, by way of example but not limitation, cam devices.

The technique provides high torque and allows the torque to be traded for speed at a given power level, and provides continuous output torque when operated as a motor or continuous braking forces when operated as a generator. A system according to the technique can be used as a transmission to couple rotary or oscillating forces from an input drive shaft to a continuous, variable-ratio output shaft.

The technique may be used to construct vehicle transmissions. Such vehicles could be of any type where power from a motor is delivered to wheels and may include an automobile, motorcycle, bicycle, snowmobile, tractor, golf cart, or other equipment. Versions with passive clutches may be used to construct variable ratio gearheads that may be coupled to electric motors and used, for example, in electric appliances, power tools, or heating and air conditioning equipment.

### BRIEF DESCRIPTION OF THE DRAWINGS

Embodiments of the invention are illustrated in the figures. However, the embodiments and figures are illustrative rather than limiting; they provide examples of the invention.

FIGS. 1A and 1B are diagrams illustrating a principle of operation.

FIGS. 2A and 2B depict top and side views, respectively, of an example of a variable ratio transmission (VRT) system.

FIG. 3 is a flowchart of an example of a method for operation of a VRT.

FIG. 4 is a graph illustrating continuous torque as tension is passed from one belt to another belt.

FIG. 5 depicts a conceptual diagram of a CVT system.

FIG. 6 depicts a system that uses two CVTs including one for coupling power from a motor to the wheels and another for coupling the wheels to a generator for regenerative braking.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

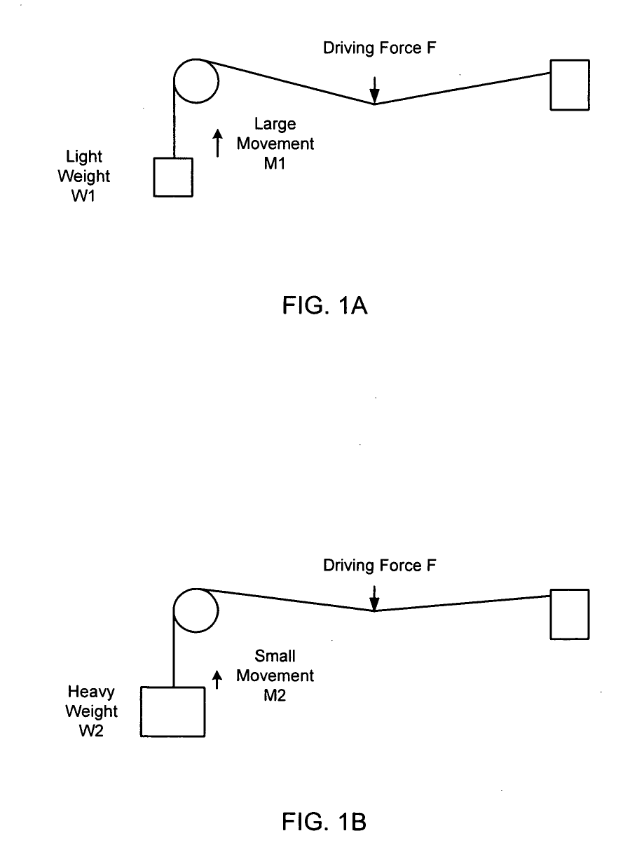

FIGS. 1A and 1B illustrate a principle of operation useful for an understanding of the teachings provided herein. FIGS. 1A and 1B show how a force can be used to deflect a belt and exert a strong force over a short distance or a weak force over a longer distance. FIG. 1A shows weight W1 attached to a rope that is anchored at one end and supported by a pulley. A force F deflects the rope near the middle and force F causes weight W1 to be lifted a distance M1. FIG. 1B shows that when the weight is replaced by a heavier weight W2, the same driving force F causes it to be lifted a smaller distance M2. Hence the rope has provided a variable transmission between the driving force F and the resisting force applied by the weight. By constructing a device that allows for multiple sequential deflections of a flexible belt, this principle can be used to construct a variety of actuators and transmissions.

U.S. patent application Ser. No. 11/033,368, which was filed on Jan. 13, 2005, and which is incorporated by reference, describes a high torque “pinch” motor with a variable ratio coupling between a driver and output. The motor includes a flexible disk or belt that couples a braking pulley and an output pulley. The output is alternately advanced or held in place while the driver returns to the position where it can again deflect the belt or disk to advance the output. However, the design does not allow for continuous output torque.

U.S. patent application Ser. No. ______ (Attorney Docket No. 57162-8002.US01) entitled “Rotary Actuator” by Horst et al. filed concurrently herewith is incorporated by reference. U.S. patent application Ser. No. ______ (Attorney Docket No. 57162-8009.US01) entitled “Linear Actuator” by Horst et al. filed concurrently herewith is incorporated by reference. U.S. patent application Ser. No. ______ (Attorney Docket No. 57162-8011.US01) entitled “Deflector Assembly” by Horst et al. filed concurrently herewith is incorporated by reference.

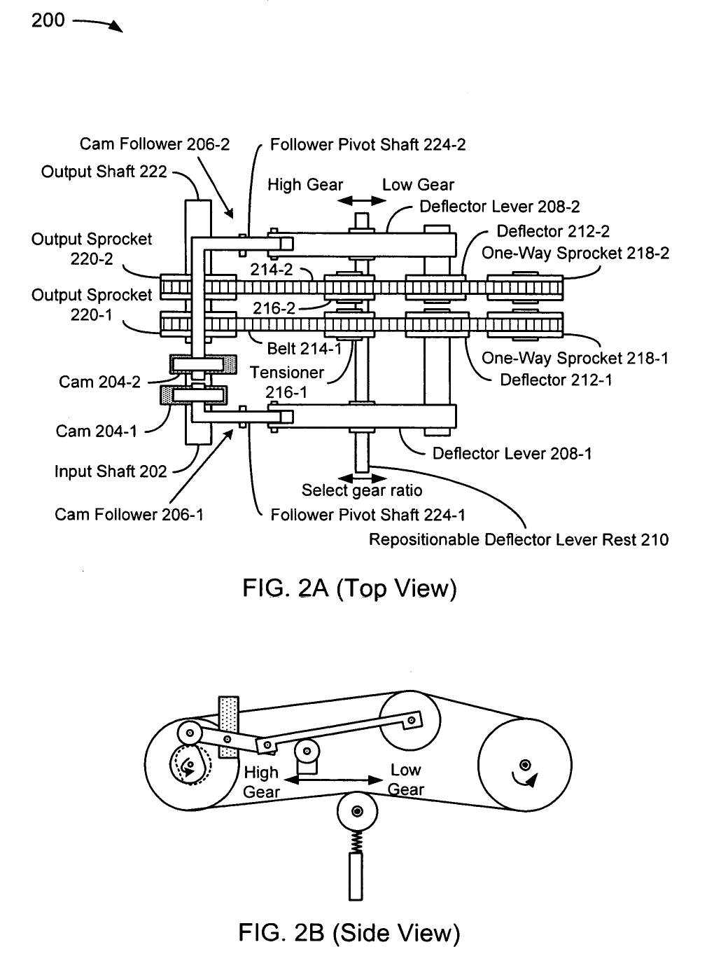

FIGS. 2A and 2B depict top and side views, respectively, of an example of a variable ratio transmission (VRT) system 200. The system 200 includes an input shaft 202, two cams 204-1 and 204-2 (referred to collectively as the cams 204), two cam followers 206-1 and 206-2 (referred to collectively as the cam followers 206), two deflector levers 208-1 and 208-2 (referred to collectively as the deflector levers 208), a repositionable deflector lever rest 210, two deflectors 212-1 and 212-2 (referred to collectively as deflectors 212), two belts 214-1 and 214-2 (referred to collectively as belts 214), two tensioners 216-1 and 216-2 (referred to collectively as tensioners 216), two one-way sprockets 218-1 and 218-2 (referred to collectively as one-way sprockets 218), two output sprockets 220-1 and 220-2 (referred to collectively as output sprockets 220), and an output shaft 222.

The input shaft 202 drives the cams 204. In an illustrative embodiment, the cams 204 are mounted out of phase with respect to one another. In the example of FIGS. 2A and 2B, the cam followers 206 include follower pivot shafts 224-1, 224-2 connected to the deflector levers 208. Since the cams 204 are, in an illustrative embodiment, mounted out of phase with respect to one another, when one of the deflector levers 208 is high, the other is low.

In the example of FIG. 2, the repositionable deflector lever rest 210 includes a bar that is juxtaposed with both of the deflector levers 208 at the same time. In an alternative, a separate repositionable deflector rest is provided for each of the deflector levers 208. In either case, the deflector lever rest 210 is juxtaposed with the deflector levers 208. In an illustrative embodiment, the deflector lever rest 210 acts as a fulcrum for the deflector levers. Moving the deflector lever rest 210 to the right drops the system 200 to a lower gear, and moving the deflector lever rest 210 to the left raises the system 200 to a higher gear. A select gear ratio input controls movement of the deflector lever rest 210, and hence at least partially affects the gear in which the system 200 operates.

The deflectors 212 are coupled to the deflector levers 208. The deflectors 212 displace the belts 214 by an amount that is at least partially dependent upon the height of the deflector levers 208. In an illustrative embodiment, the deflectors 212 include belt deflector sprockets. Sprockets are particularly useful in implementations where the belts 214 are chains. The tensioners 216 take slack out of the belts 214.

The one-way sprockets 218 ensure that the belts 214 do not backslide. Thus, the one-way sprockets 218 act as a braking mechanism or clutch for the belts 214. The output sprockets 220 are coupled to the output shaft 222, and the movement of the belts 214 is transferred to the output shaft 222 thereby.

In the example of FIGS. 2A and 2B, the system 200 includes one-way clutches, dual belts, and an externally settable ratio. The use of one-way clutches instead of active brakes restricts the operation to a single direction, but simplifies the control. In alternative embodiments, instead of dual belts, three or more belts could be used implementing principles similar to those described with reference to the example of FIGS. 2A and 2B. In implementations with three or more belts, the cams may be mounted to be out of phase with each other. In an alternative embodiment, the ratio need not be set externally, but could rather be based upon, for example, load on the belt(s).

The system of FIGS. 2A and 2B can be used as a variable ratio reducing gearhead to be attached to a motor, or at a larger scale, used as a CVT for an automobile or other vehicle. In an illustrative embodiment, the CVT does not have sliding elements. Advantageously, the CVT does not require traction fluid unlike some elliptical CVT implementations. In a specific implementation, moving components of the CVT can ride on high quality bearings for highly efficient operation. The one-way clutches may be ball clutches, roller clutches, sprag clutches, or other applicable known or convenient clutches. Some limitations on the torque of the CVT include the strength of the belts/chains and the torque limits of the clutches. However, these components are already commercially available in strengths that exceed those required for automotive applications.

The belts of the example of FIGS. 2A and 2B are associated with actuators that use two belts or cables to provide continuous output torque. However, if one belt is broken or omitted, the mechanism will still function as long as there is enough inertia to continue the movement during the restore cycle when the belt is pulled tight. Hence, advantageously, all designs include an inherent fault-tolerant feature that provides a degraded but functional operation mode.

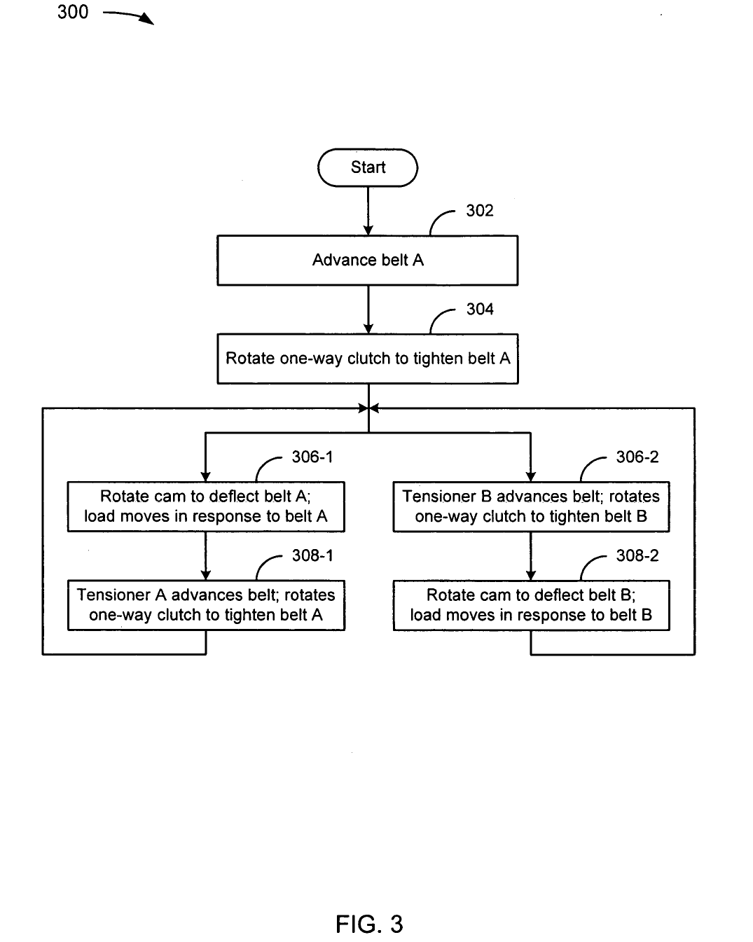

FIG. 3 is a flowchart of an example of a method for operation of a VRT. This method and other methods are depicted as modules arranged serially or in parallel. However, modules of the methods may be reordered, or arranged for parallel or serial execution as appropriate.

In the example of FIG. 3, the flowchart 300 starts at module 302 with advancing belt A. Belt A may be either of dual (or more) belts that are part of a continuous variable ratio motor. It may be noted that module 302 is optional in that belt A could be advanced later at modules 306-1, 308-1. The necessity of module 302, therefore, is dependent upon implementation and/or circumstances. In an illustrative embodiment, a tensioner A advances belt A.

In the example of FIG. 3, the flowchart 300 continues at module 304 with rotating a one-way clutch to tighten belt A. It may be noted that module 304 is optional in that if the one-way clutch is initially already rotated and/or belt A is already tightened, the module 304 is not necessary to tighten belt A. The necessity of module 304, therefore, is dependent upon implementation and/or circumstances. In an illustrative embodiment, the tensioner A causes the one-way clutch to rotate, thereby tightening belt A.

In the example of FIG. 3, the flowchart 300 continues at modules 306-1 and 306-2, which are executed simultaneously. It may be noted that precise simultaneous execution may be impossible to achieve. Accordingly, “simultaneous” is intended to mean substantially simultaneous, or approximately simultaneous. Moreover, certain applications may require more or less accurate approximations of simultaneity. At module 306-1, a cam is rotated to deflect belt A. This has the result of moving a load in response to the deflection of belt A. At module 306-2, a tensioner B advances belt B and rotates a one-way clutch to tighten belt B. Thus, the cam is rotated to deflect belt A while simultaneously tightening belt B.

In the example of FIG. 3, the flowchart 300 continues at modules 308-1 and 308-2, which are executed simultaneously. At module 308-1, tensioner A advances belt A and rotates a one-way clutch to tighten belt A. At module 308-2, the cam is rotated to deflect belt B, and the load may be moved thereby. Thus, the cam is rotated to deflect belt B while simultaneously tightening belt A.

In the example of FIG. 3, the flowchart 300 continues at the modules 306-1, 306-2, as described previously. In this way, continuous motion of the output is sustained. It should be noted that the flowchart 300 makes reference to a single cam, but that two cams could be used in alternative embodiments (e.g., a cam A and a cam B).

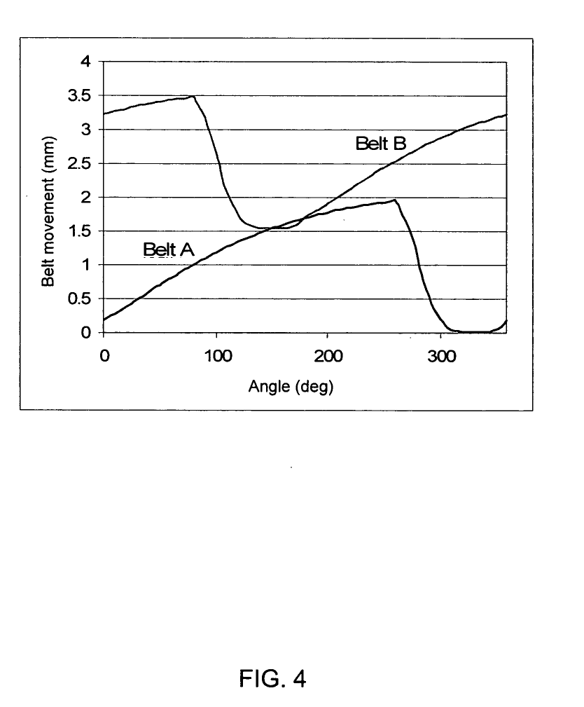

FIG. 4 shows a plot of the rotation angle of the two cams versus the belt movement caused by the deflection of the belt. The output shaft movement in rotations is this belt deflection amount divided by the circumference of the output sprocket. FIG. 4 is plotted for a cam shape similar to that shown in FIG. 2 in which the radius increases quickly near its minimum radius, increases slowly as it approaches its maximum radius, then quickly decreases back to the minimum radius. This shape has an increasing radius for about 270 degrees and a decreasing radius for the other 90 degrees. By having the increasing radius more than 180 degrees, it is possible to have part of each cam rotation with the load shared between the two belts, allowing smooth operation with very little torque ripple.

The shape of the cam also allows for different drive ratios simply by adjusting the angle at which the cam touches and begins to deflect the belt. If the tensioner positions the belt to be tangent to the minimum radius of the cam, then the belt is deflected by the first 180 degrees of cam rotation. If the tensioner moves the belt support such that it contacts the cam only when it reaches 90 degrees of rotation, then the cam deflects the belt between 90 and 270 degrees. With this cam design, the radius delta of the cam between 0 and 180 degrees is greater than between 90 and 270 degrees, hence the belt is deflected less and movement of the tensioner has the effect of reducing the output speed, effectively dropping into a lower gear.

FIG. 4 also shows that this cam design has a large region where each degree of cam rotation results in a nearly linear change in belt displacement. This shows that the output torque will be nearly constant and independent of cam position. The graph for belt B has been displaced by the amount that belt A would have moved the output load. Note that near the points where the two graphs intersect, the slope of the belt A line is less than that of belt B, hence belt B is accelerating to catch up and take over the load from belt A.

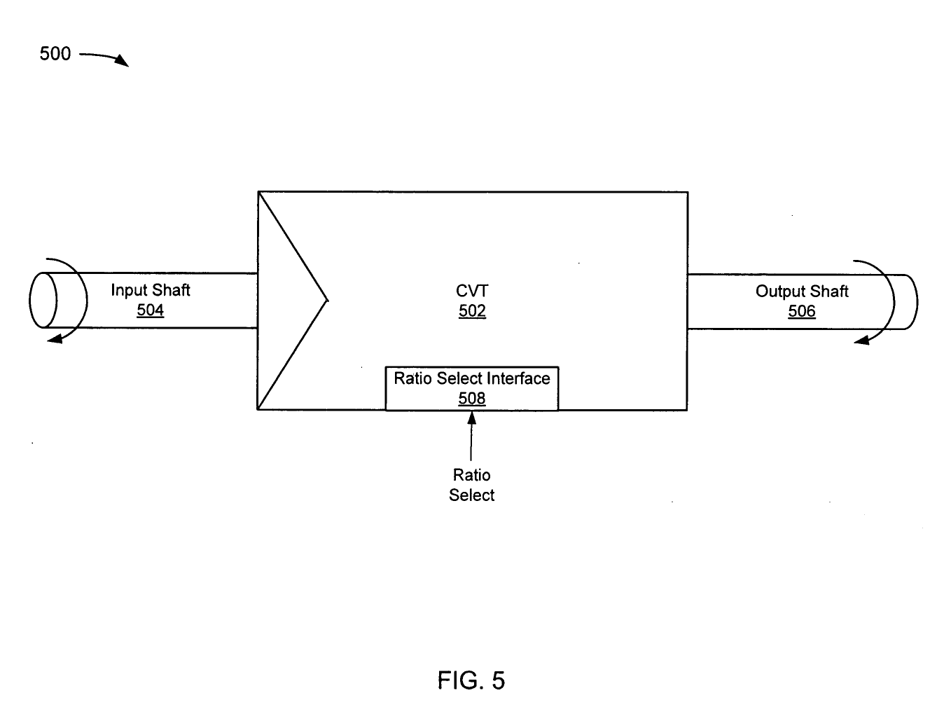

FIG. 5 depicts a conceptual diagram of a continuously variable transmission (CVT) system 500. The system 500 includes a CVT 502, an input shaft 504, an output shaft 506, and a ratio select interface 508. In an illustrative embodiment, the CVT 502 receives input from the rotating input shaft 504 and delivers power to the rotating output shaft 506 according to a ratio select input received on the ratio select interface 508. The ratio may be selected by a mechanical linkage, solenoid, or other type of actuator used to change the ratio of input shaft rotations to output shaft rotations.

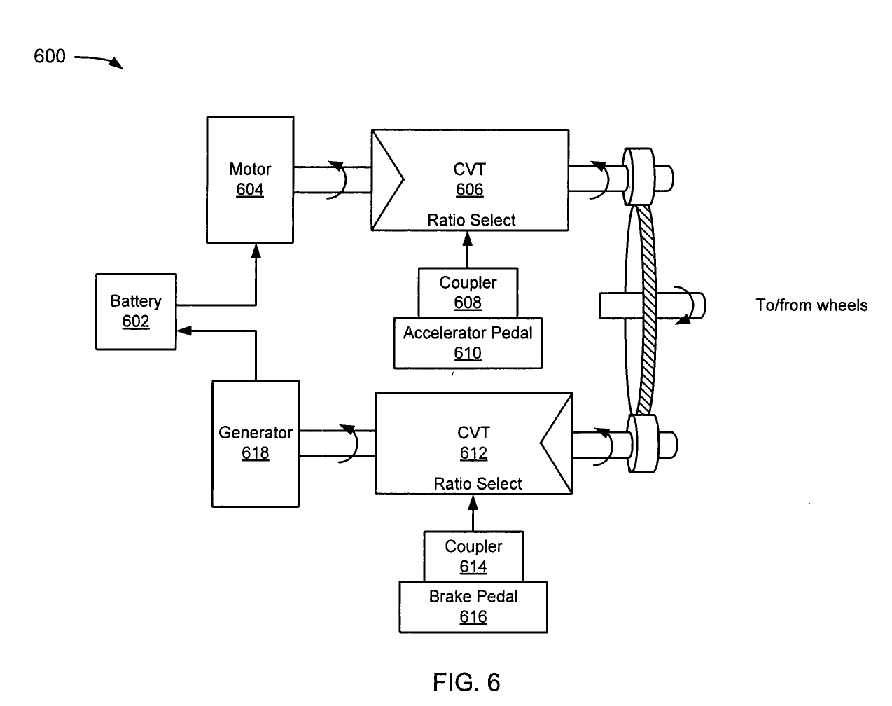

FIG. 6 depicts a system 600 that uses two CVTs including one for coupling power from a motor to the wheels and another for coupling the wheels to a generator for regenerative braking. FIG. 6 is intended to illustrate an example of an arrangement of two CVTs for braking and accelerating a vehicle. The vehicle described could be of any type where power from a motor is delivered to wheels and may include an automobile, motorcycle, bicycle, snowmobile, tractor, golf cart, or other equipment. The wheels are coupled to the CVTs through gears, belts, or other means to provide output power or braking to the wheels. The system 600 includes a battery 602, a motor 604, a CVT 606, a coupler 608, an accelerator pedal 610, a CVT 612, a coupler 614, a brake pedal 616, and a generator 618.

In the example of FIG. 6, the battery 602 provides power to the motor 604, which drives the CVT 606. The battery and motor may be any known or convenient battery and motor. The CVT 606 may be similar to that described with reference to FIG. 2, or as described by way of example but not limitation in any of the co-pending U.S. patent applications having attorney docket numbers 57162-8002.US01, 57162-8009.US01, and/or 57162-8011.US01, each of which is incorporated by reference.

In the example of FIG. 6, the accelerator pedal 610 is coupled to the ratio adjustment mechanism of the acceleration CVT 606 through the coupler 608. The coupler 608 may include a mechanical linkage, an actuator under the control of an embedded computer that also monitors and adjusts the engine speed in order to optimize economy or performance, or some other applicable known or convenient means. Output from the CVT 606 is sent to the wheels.

The CVT 612 receives input from the CVT 606 and/or the wheels. The brake pedal 616 is coupled through the coupler 614 to the ratio adjustment mechanism of the CVT 612, which may be referred to as the braking CVT. The coupler 614 may include a mechanical linkage, an actuator under the control of an embedded computer and sensors used to regulate and control anti-lock braking, or some other applicable known or convenient means. Output from the CVT 612 is sent to the generator 618, which charges the battery 602.

The generator 618 may have its own fixed input gear ratio designed to match the operating speed of the generator 618 with the output speed range of the CVT 612. This gear ratio is set based on the desired braking force and the maximum speed and current of the generator 618. In cases when the battery 602 is fully charged or when braking forces would cause the generator 618 to spin faster than its design limit, additional braking can be supplied by switching a resistive load in place of the battery 602 or by increasing the drag of the generator 618 by adding a governor or additional flywheel mass.

The use of a CVT for braking arrangement overcomes a disadvantage of the regenerative braking mechanisms of many current hybrid, fuel cell and electric vehicles. In these vehicles, the wheels have a fixed ratio to a single motor/generator, and the maximum braking force changes as the vehicle slows. As the vehicle comes to a stop, the regenerative braking force decreases because the fixed ratio causes the generator to rotate more slowly. The prior regenerative braking systems are therefore useful only as a braking assist and require traditional friction brakes to take over at some point as the vehicle comes to a stop.

The system 600 overcomes this problem by coupling the requested braking force to the ratio adjustment of the CVT 612. As more braking force is required, the CVT 612 causes the generator 618 to spin more quickly, thereby recovering more energy and applying more braking force. The ratio can continue to increase all the way until the vehicle is stopped, minimizing the need to use friction brakes.

One or both of the CVTs 606, 612 may be any existing CVT, one based on flexing belts as shown in FIG. 2, or one described fully in a patent pending from the same provisional application. The flex-based CVT is advantageous because its small size and weight will allow a vehicle to have two separate CVTs, with one optimized for the transmission and the other optimized for the braking.

The invention is not limited to the specific embodiments described. The number of belts, brakes and drivers are not restricted to the number shown and may be increased. The belts can be implemented by chains, timing belts, steel belts, V-belts, cables, or any other type of flexible material. The materials used in construction are not limited to the ones described. In an embodiment, the ratio adjusting mechanism allows for an external control to set the desired ratio via mechanical, electrical, hydraulic or other means for adjusting the pivot point of a cam follower mechanism or other applicable device.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A continuously variable transmission (CVT) system comprising:
a one-way clutch;
an output shaft;
a belt operationally connected to the one-way clutch and to the output shaft;
a cam shaft for deflecting the belt;
an input shaft, coupled to the cam shaft, for driving the cam shaft.

2. The system of claim 1, wherein the belt is a first belt and the cam shaft is a first cam shaft, further comprising:
a second belt;
a second cam shaft for deflecting the second belt.

3. The system of claim 2, further comprising a fault-tolerant feature that enables continued operation by the first belt if the second belt breaks, as long as there is enough inertia to continue movement during a restore cycle when the first belt is pulled tight.

4. The system of claim 1, wherein the cam shaft includes:
a cam driven by the input shaft,
a deflector lever having a first end and a second end;
a cam follower coupled to the cam and to the first end of the deflector lever such that when the cam lowers the cam follower the first end of the deflector lever is raised and the second end of the deflector lever is lowered, and when the cam raises the cam follower the first end of the deflector lever is lowered and the second end of the deflector lever is raised;
a deflector coupled to the second end of the deflector lever;
wherein, in operation, the deflector is conterminous with the belt.

5. The system of claim 1, further comprising an input to control acceleration of a vehicle.

6. The system of claim 1, further comprising an input to control braking of a vehicle.

7. The system of claim 1, further comprising a tensioner for removing slack from the belt.

8. The system of claim 1, further comprising an output sprocket coupled to the output shaft.

9. The system of claim 1, further comprising a deflector for deflecting the belt a variable amount at least partially depending upon load on the belt.

10. The system of claim 1, further comprising a deflector for deflecting the belt by a variable amount based at least in part on input from a vehicle control system.

11. The system of claim 1, further comprising a deflector for deflecting the belt by a variable amount based at least in part on the brake pedal or accelerator pedal position.

12. A method comprising:
coupling a wheel of a vehicle to input of a continuously variable transmission (CVT);
coupling output of the CVT to a generator;
coupling a brake pedal of the vehicle to a ratio adjustment of the CVT.

13. The method of claim 12, further comprising providing a flexing belt within the CVT.

14. The method of claim 12, wherein the CVT is a first CVT, further comprising:
coupling a motor to input of a second CVT;
coupling output of the second CVT to the wheel;
coupling an accelerator pedal of the vehicle to a ratio adjustment of the second CVT.

15. A method comprising:
setting a first transmission ratio;
deflecting a belt between a first position and a second position, wherein the distance from the first position to the second position is based at least in part on the first transmission ratio;
advancing an output a first amount based on the difference between the first position and the second position;
changing from the first transmission ratio to a second transmission ratio;
deflecting the belt from the first position to a third position, wherein the distance from the first position to the third position is based at least in part on the second transmission ratio;
advancing the output a second amount based on the difference between the first position and the third position.

16. The method of claim 15, further comprising changing from the first transmission ratio to the second transmission ratio in response to a change in output load.

17. The method of claim 15, further comprising determining the first position and the second position based on a first engagement point of a cam.

18. The method of claim 15, further comprising changing a first or second engagement point of a cam to cause the belt to deflect between the first position and the third position in response to a change in output load.

19. The method of claim 15, further comprising moving a repositionable deflector rest to change from the first transmission ratio to the second transmission ratio.

20. The method of claim 15, further comprising changing the length of a spring to change from the first transmission ratio to the second transmission ratio in response to a change in output load.
